(19) United States
(12) Patent Application Publication
(10) Pub. No.: US 2020/0302799 A1
(43) Pub. Date: Sep. 24, 2020

(54) UNMANNED AERIAL VEHICLE CONTROL METHOD AND DEVICE, AND UNMANNED AERIAL VEHICLE OPERATING METHOD AND DEVICE

(71) Applicant: BEIJING XIAOMI MOBILE SOFTWARE CO., LTD., Beijing (CN)

(72) Inventor: Wei HONG, Beijing (CN)

(73) Assignee: BEIJING XIAOMI MOBILE SOFTWARE CO., LTD., Beijing (CN)

(21) Appl. No.: 16/758,202

(22) PCT Filed: Oct. 27, 2017
(86) PCT No.: PCT/CN2017/108048

§ 371 Date: Apr. 22, 2020

(51) Int. Cl. G08G 5/00

(52) U.S. Cl. CPC G08G 5/003; B64C 39/024; G08G 5/0013

(57) ABSTRACT

An unmanned aerial vehicle control method includes: reporting the flight path of an unmanned aerial vehicle to a core network by means of a base station accessed by a controller so that the base station accessed by the controller acquires from the core network a base station covered by the flight path; and sending control information to the base station accessed by the controller so that the base station accessed by the controller sends a paging signaling which carries the control information to the base station covered by the flight path.

### TECHNICAL FIELD

The present disclosure generally relates to the technical field of communication, and more particularly, to a method and device for controlling an Unmanned Aerial Vehicle (UAV), a method and device for operating a UAV, a controller, a base station, a UAV and a computer-readable storage medium.

### BACKGROUND

An unmanned aerial vehicle is referred to as UAV, which is a non-manned aerial vehicle operated by a radio remote control device and its own program control device. Unmanned aerial vehicles, actually collectively referred to as UAVs, may be technically divided into unmanned fixed-wing aircrafts, unmanned vertical take-off and landing aircrafts, unmanned airships, unmanned helicopters, unmanned multi-rotor aircrafts, unmanned paraglider aircraft, etc.

Along with a rapid development of technologies, reduction of cost and improvement of functions, UAVs have been increasingly used by ordinary consumers. At present, UAVs are applied to the fields of aerial photography, agriculture, plant protection, mini self-timers, express transportation, disaster relief, wild animal observation, infectious disease monitoring, surveying and mapping, news reporting, power inspection, disaster rescue, video shooting, romance creation and the like, and uses of UAVs are greatly extended. Various countries are actively extending industrial applications and developing UAV technologies.

For further extending the application range of UAVs, the 3rd Generation Partnership Project (3GPP) approves a project of Enhanced Support for Aerial Vehicles to research and standardize provision of required service for UAVs by cellular networks.

A UAV usually has two flight modes. One flight mode is a fixed mode, namely an operator plans a flight path of the UAV in a controller, then the UAV may fly according to the planned path and the controller is not required to control the UAV every minute. The other flight mode is a dynamic mode, namely the operator remotely controls the UAV in real time through the controller. When the UAV is switched from the fixed mode to the dynamic mode, the controller is required to rapidly find and control the UAV that needs to be controlled.

In related art, a cellular network pages a whole tracking area through a core network to find and control a UAV that needs to be controlled. However, the tracking area includes a large number of base stations, and paging through the core network may bring a high signaling load and a relatively long delay.

### SUMMARY

In view of this, the present application discloses a method and device for controlling a UAV, a method and device for operating a UAV, a controller, a base station, a UAV and a computer-readable storage medium, to rapidly find and control a UAV that needs to be controlled.

According to a first aspect of embodiments of the present disclosure, there is provided a method for controlling a UAV, which is applied to a controller and includes the following operations.

A flight path of a UAV is reported to a core network through a base station accessed by the controller, to enable the base station accessed by the controller to obtain information about base stations covered by the flight path from the core network.

Control information is sent to the base station accessed by the controller, to enable the base station accessed by the controller to send paging signaling containing the control information to the base stations covered by the flight path.

According to a second aspect of the embodiments of the present disclosure, there is provided a method for controlling a UAV, which is applied to a base station accessed by a controller and includes the following operations.

A flight path, reported by the controller, of a UAV is received.

The flight path is reported to a core network.

Information about base stations covered by the flight path is received from the core network.

Control information sent by the controller is received.

Paging signaling containing the control information is sent to the base stations covered by the flight path, to enable a base station accessed by the UAV to send the paging signaling to the UAV.

In an embodiment, the operation that the paging signaling containing the control information is sent to the base stations covered by the flight path may include the following action.

The paging signaling containing the control information is sent to the base stations covered by the flight path through an X2 interface or an S1 interface.

In an embodiment, the method may further include the following operations.

After the paging signaling containing the control information is sent to the base stations covered by the flight path, an identifier, sent by the base station accessed by the UAV after a connection is established with the UAV, of the base station accessed by the UAV is received.

The control information is sent to the base station accessed by the UAV according to the received identifier.

According to a third aspect of the embodiments of the present disclosure, there is provided a method for controlling a UAV, which is applied to a base station accessed by a UAV and includes the following operations.

Paging signaling containing control information is received from a base station accessed by a controller.

The paging signaling is sent to the UAV for the UAV to execute an operation corresponding to the control information in the paging signaling.

In an embodiment, the method may further include the following operations.

After the paging signaling is sent to the UAV, an identifier of the base station accessed by the UAV is sent to the base station accessed by the controller.

The control information sent by the base station accessed by the controller according to the identifier is received.

According to a fourth aspect of the embodiments of the present disclosure, there is provided a method for operating a UAV, which is applied to a UAV and includes the following operations.

Paging signaling containing control information is received from a base station accessed by the UAV.

The control information is acquired from the received paging signaling.

An operation corresponding to the control information is executed.

In an embodiment, the method may further include the following operations.

If the UAV is in an idle state, the UAV is switched to a connected state after the paging signaling is received.

A connection is established with the base station accessed by the UAV.

According to a fifth aspect of embodiments of the present disclosure, there is provided a device for controlling a UAV, which is applied to a controller and includes a first reporting module and a first sending module.

The first reporting module is configured to report a flight path of a UAV to a core network through a base station accessed by the controller, to enable the base station accessed by the controller to obtain information about base stations covered by the flight path from the core network.

The first sending module is configured to send control information to the base station accessed by the controller, to enable the base station accessed by the controller to send paging signaling containing the control information to the base stations covered by the flight path reported by the first reporting module.

According to a sixth aspect of the embodiments of the present disclosure, there is provided a device for controlling a UAV, which is applied to a base station accessed by a controller and includes a first receiving module, a second reporting module, a second receiving module, a third receiving module and a second sending module.

The first receiving module is configured to receive a flight path, reported by the controller, of a UAV

The second reporting module is configured to report the flight path received by the first receiving module to a core network.

The second receiving module is configured to receive information about base stations covered by the flight path reported by the second reporting module from the core network.

The third receiving module is configured to receive control information sent by the controller.

The second sending module is configured to send paging signaling containing the control information received by the third receiving module to the base stations covered by the flight path, to enable a base station accessed by the UAV to send the paging signaling to the UAV.

In an embodiment, the sending module may be configured to:

send the paging signaling containing the control information to the base stations covered by the flight path through an X2 interface or an S1 interface.

In an embodiment, the device may further include a fourth receiving module and a third sending module.

The fourth receiving module is configured to, after the second sending module sends the paging signaling containing the control information to the base stations covered by the flight path, receive an identifier, sent by the base station accessed by the UAV after a connection is established with the UAV, of the base station accessed by the UAV

The third sending module is configured to send the control information to the base station accessed by the UAV according to the identifier received by the fourth receiving module.

According to a seventh aspect of the embodiments of the present disclosure, there is provided a device for controlling a UAV, which is applied to a base station accessed by a UAV and includes a fifth receiving module and a fourth sending module.

The fifth receiving module is configured to receive paging signaling containing control information from a base station accessed by a controller.

The fourth sending module is configured to send the paging signaling received by the fifth receiving module to the UAV, for the UAV to execute an operation corresponding to the control information in the paging signaling.

In an embodiment, the device may further include a fifth sending module and a sixth receiving module.

The fifth sending module is configured to, after the fourth sending module sends the paging signaling to the UAV, send an identifier of the base station accessed by the UAV to the base station accessed by the controller.

The sixth receiving module is configured to receive the control information sent by the base station accessed by the controller according to the identifier sent by the fifth sending module.

According to an eighth aspect of the embodiments of the present disclosure, there is provided a device for operating a UAV, which is applied to a UAV and includes a seventh receiving module, an acquisition module and an operating module.

The seventh receiving module is configured to receive paging signaling containing control information from a base station accessed by the UAV.

The acquisition module is configured to acquire the control information from the paging signaling received by the seventh receiving module.

The operating module is configured to execute an operation corresponding to the control information acquired by the acquisition module.

In an embodiment, the device may further include a switching module and an establishment module.

The switching module is configured to, if the UAV is in an idle state, switch the UAV to a connected state after the seventh receiving module receives the paging signaling.

The establishment module is configured to, after the switching module switches the UAV to the connected state, establish a connection with the base station accessed by the UAV.

According to a ninth aspect of the embodiments of the present disclosure, a controller is provided, which includes:

a processor; and

memory for storing a set of instructions executable by the processor,

wherein the processor is configured to:

report a flight path of a UAV to a core network through a base station accessed by the controller, to enable the base station accessed by the controller to obtain information about base stations covered by the flight path from the core network; and

send control information to the base station accessed by the controller, to enable the base station accessed by the controller to send paging signaling containing the control information to the base stations covered by the flight path.

According to a tenth aspect of the embodiments of the present disclosure, a base station is provided, which includes:

a processor; and

memory for storing a set of instructions executable by the processor,

wherein the processor is configured to:

receive a flight path, reported by a controller, of a UAV;

report the flight path to a core network;

receive information about base stations covered by the flight path from the core network;

receive control information sent by the controller; and

send paging signaling containing the control information to the base stations covered by the flight path, to enable a base station accessed by the UAV to send the paging signaling to the UAV.

According to an eleventh aspect of the embodiments of the present disclosure, a base station is provided, which includes:

a processor; and

memory for storing a set of instructions executable by the processor,

wherein the processor is configured to:

receive paging signaling containing control information from a base station accessed by a controller; and

send the paging signaling to a UAV, for the UAV to execute an operation corresponding to the control information in the paging signaling.

According to a twelfth aspect of the embodiments of the present disclosure, a

UAV is provided, which includes:

a processor; and

memory for storing a set of instructions executable by the processor,

wherein the processor is configured to:

receive paging signaling containing control information from a base station accessed by the UAV;

acquire the control information from the received paging signaling; and

execute an operation corresponding to the control information.

According to a thirteenth aspect of the embodiments of the present disclosure, a computer-readable storage medium is provided, the computer-readable storage medium having stored therein computer instructions that, when being executed by a processor, cause the processor to implement the steps of the method for controlling a UAV.

According to a fourteenth aspect of the embodiments of the present disclosure, a computer-readable storage medium is provided, the computer-readable storage medium having stored therein computer instructions that, when being executed by a processor, cause the processor to implement the steps of the method for controlling a UAV.

According to a fifteenth aspect of the embodiments of the present disclosure, a computer-readable storage medium is provided, the computer-readable storage medium having stored therein computer instructions that, when being executed by a processor, cause the processor to implement the steps of the method for controlling a UAV.

According to a sixteenth aspect of the embodiments of the present disclosure, a computer-readable storage medium is provided, the computer-readable storage medium having stored therein computer instructions that, when being executed by a processor, cause the processor to implement the steps of the method for operating a UAV.

The technical solutions provided in the embodiments of the present disclosure may have the following beneficial effects.

The flight path of the UAV is reported to the core network through the base station accessed by the controller to enable the base station accessed by the controller to obtain information about the base stations covered by the flight path from the core network, and the control information is sent to the base station accessed by the controller to enable the base station accessed by the controller to send the paging signaling containing the control information to the base stations covered by the flight path rather than send the paging signaling to a whole tracking area, so that a paging signaling load is low, and the UAV required to be controlled may be rapidly found and controlled.

The information about base stations covered by the flight path is received from the core network, to enable the base station accessed by the controller to send the paging signaling containing the control information to the base stations covered by the flight path rather than send the paging signaling to the whole tracking area, so that the paging signaling load is low, and the UAV required to be controlled may be rapidly found and controlled.

The paging signaling containing the control information is received from the base station accessed by the controller, and the paging signaling is sent to the UAV for the UAV to execute the operation according to the control information in the paging signaling, so that the UAV required to be controlled may be rapidly found and controlled.

The paging signaling containing the control information is received from the base station accessed by the UAV, and the operation corresponding to the control information acquired from the paging signaling is executed, so that the operation may be executed according to a control instruction of the controller.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart showing a method for controlling a UAV, according to an exemplary embodiment of the present application.

FIG. 2A is a flowchart showing another method for controlling a UAV, according to an exemplary embodiment of the present application.

FIG. 2B is a flowchart showing another method for controlling a UAV, according to an exemplary embodiment of the present application.

FIG. 3A is a flowchart showing another method for controlling a UAV, according to an exemplary embodiment of the present application.

FIG. 3B is a flowchart showing another method for controlling a UAV, according to an exemplary embodiment of the present application.

FIG. 4 is a flowchart showing a method for operating a UAV, according to an exemplary embodiment of the present application.

FIG. 5 is a signaling flowchart showing a method for controlling a UAV, according to an exemplary embodiment of the present application.

FIG. 6 is a block diagram of a device for controlling a UAV, according to an exemplary embodiment.

FIG. 7A is a block diagram of another device for controlling a UAV, according to an exemplary embodiment.

FIG. 7B is a block diagram of another device for controlling a UAV, according to an exemplary embodiment.

FIG. 8A is a block diagram of another device for controlling a UAV, according to an exemplary embodiment.

FIG. 8B is a block diagram of another device for controlling a UAV, according to an exemplary embodiment.

FIG. 9A is a block diagram of a device for operating a UAV, according to an exemplary embodiment.

FIG. 9B is a block diagram of another device for operating a UAV, according to an exemplary embodiment.

FIG. 10 is a block diagram of a device applied to UAV control, according to an exemplary embodiment.

FIG. 11 is a block diagram of another device applied to UAV control, according to an exemplary embodiment.

FIG. 12 is a block diagram of a device applied to UAV operation, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

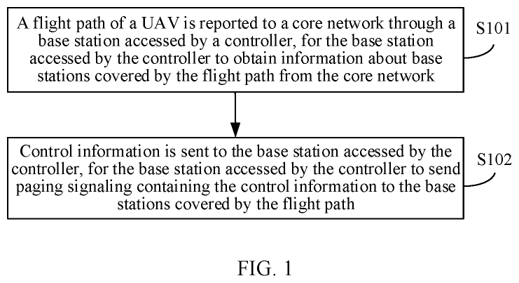

FIG. 1 is a flowchart showing a method for controlling a UAV, according to an exemplary embodiment of the present application. The embodiment is described from a controller side. As shown in FIG. 1, the method for controlling a UAV includes the following operations.

In S101, a flight path of a UAV is reported to a core network through a base station accessed by a controller, to enable the base station accessed by the controller to obtain information about base stations covered by the flight path from the core network.

When the controller sets the flight path for the UAV and the UAV takes off, the controller may report the flight path to the base station accessed by it through a cellular network, and then the base station may report the flight path to the core network. In a fixed mode, the flight path of the UAV is fixed, so that the core network may predetermine the base stations of the cellular network that the UAV may pass. The core network, after receiving the flight path reported by the base station accessed by the controller, may check base stations covered by the flight path and notify information of the base stations to the base station accessed by the controller.

In S102, control information is sent to the base station accessed by the controller, to enable the base station accessed by the controller to send paging signaling containing the control information to the base stations covered by the flight path.

When the UAV is required to be found and controlled, the controller may send the control information for the UAV to the base station accessed by it. The base station accessed by the controller, after receiving the control information, may send the paging signaling to the base stations covered by the flight path, and the paging signaling contains the control information.

If there is an X2 interface between the base station and the base station, the paging signaling may be sent through the X2 interface. If there is no X2 interface between the base station and the base station, the paging signaling may be sent through an S1 interface, or the paging signaling is relayed through the X2 interface.

The UAV, after receiving the paging signaling containing the control information from the base station accessed by it, may execute an operation corresponding to the control information.

According to the embodiment, the flight path of the UAV is reported to the core network through the base station accessed by the controller, to enable the base station accessed by the controller to obtain the information about the base stations covered by the flight path from the core network, and the control information is sent to the base station accessed by the controller, to enable the base station accessed by the controller to send the paging signaling containing the control information to the base stations covered by the flight path rather than send the paging signaling to a whole tracking area, so that a paging signaling load is low, and the UAV required to be controlled may be rapidly found and controlled.

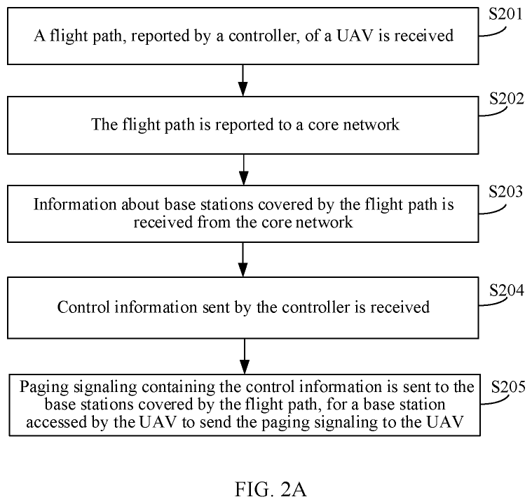

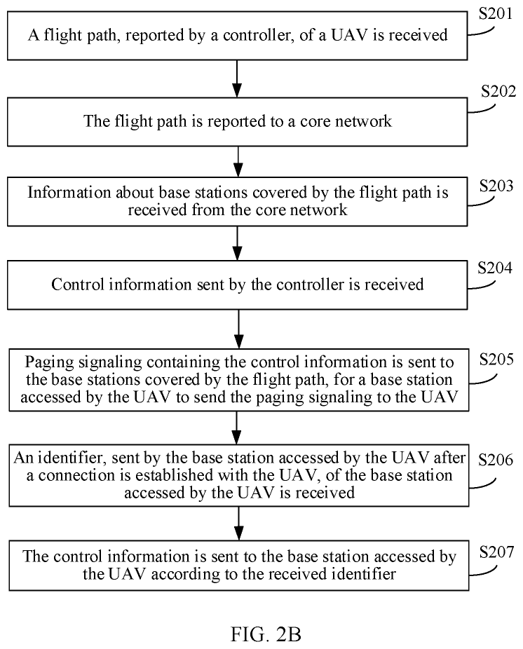

FIG. 2A is a flowchart showing another method for controlling a UAV, according to an exemplary embodiment of the present application. The embodiment is described from a base station side accessed by a controller. As shown in FIG. 2A, the method for controlling a UAV includes the following operations.

In S201, a flight path, reported by the controller, of a UAV is received.

In S202, the flight path is reported to a core network.

The controller may report the flight path to a base station accessed by it through a cellular network, and then the base station may report the flight path to the core network.

In S203, information about base stations covered by the flight path is received from the core network.

The core network, after receiving the flight path reported by the base station accessed by the controller, may check the base stations covered by the flight path and notify information of the base stations to the base station accessed by the controller.

In S204, control information sent by the controller is received.

When the UAV is required to be found and controlled, the controller may send the control information for the UAV to the base station accessed by it.

In S205, paging signaling containing the control information is sent to the base stations covered by the flight path, to enable a base station accessed by the UAV to send the paging signaling to the UAV.

If there is an X2 interface between the base station accessed by the controller and the base station covered by the flight path, the paging signaling may be sent through the X2 interface. If there is no X2 interface between the base station accessed by the controller and the base station covered by the flight path, the paging signaling may be sent through an S1 interface, or the paging signaling is relayed through the X2 interface.

According to the embodiment, the information about the base stations covered by the flight path is received from the core network, to enable the base station accessed by the controller to send the paging signaling containing the control information to the base stations covered by the flight path rather than send the paging signaling to a whole tracking area, so that a paging signaling load is low, and the UAV required to be controlled may be rapidly found and controlled.

FIG. 2B is a flowchart showing another method for controlling a UAV, according to an exemplary embodiment of the present application. As shown in FIG. 2B, after S205, the method for controlling a UAV may further include the following operations.

In S206, an identifier, sent by the base station accessed by the UAV after a connection is established with the UAV, of the base station accessed by the UAV is received.

After the base station accessed by the UAV sends the paging signaling to the UAV, if the UAV is in an idle state, the UAV, after receiving the paging signaling, is switched to a connected state and establishes the connection with the accessed base station. The accessed base station may notify its own identifier to the base station accessed by the controller. The base station accessed by the controller may subsequently directly send the control information from the controller to the base station accessed by the UAV, and the base station accessed by the UAV may send the control information to the UAV.

In S207, the control information is sent to the base station accessed by the UAV according to the received identifier.

According to the embodiment, the identifier, sent by the base station accessed by the UAV after the connection is established with the UAV, of the base station accessed by the UAV is received, and then the base station accessed by the controller may directly send the control information to the base station accessed by the UAV according to the received identifier, so that transmission efficiency of the control information is improved.

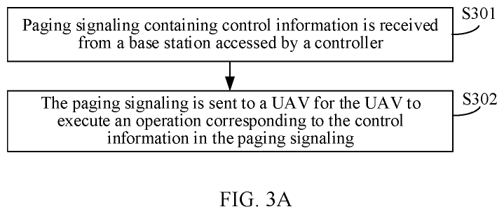

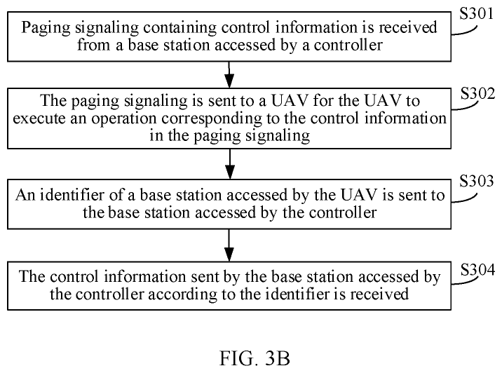

FIG. 3A is a flowchart showing another method for controlling a UAV, according to an exemplary embodiment of the present application. The embodiment is described from a base station side accessed by a UAV. As shown in FIG. 3A, the method for controlling a UAV includes the following operations.

In S301, paging signaling containing control information is received from a base station accessed by a controller.

When the UAV is required to be found and controlled, the controller may send the control information for the UAV to the base station accessed by it, and the base station accessed by the controller, after receiving the control information, may send the paging signaling to base stations covered by a flight path. The paging signaling contains the control information. The base stations covered by the flight path include a base station accessed by the UAV.

In S302, the paging signaling is sent to the UAV, to enable the UAV to execute an operation corresponding to the control information in the paging signaling.

The base station accessed by the UAV, after receiving the paging signaling containing the control information, may send the paging signaling to the UAV, and the UAV, after receiving the paging signaling, may execute the operation corresponding to the control information in the paging signaling.

According to the embodiment, the paging signaling containing the control information is received from the base station accessed by the controller, and the paging signaling is sent to the UAV for the UAV to execute the operation according to the control information in the paging signaling, so that the UAV required to be controlled may be rapidly found and controlled.

FIG. 3B is a flowchart showing another method for controlling a UAV, according to an exemplary embodiment of the present application. As shown in FIG. 3B, after S302, the method for controlling a UAV may further include the following operations.

In S303, an identifier of a base station accessed by the UAV is sent to the base station accessed by the controller.

After the base station accessed by the UAV sends the paging signaling to the UAV, if the UAV is in an idle state, the UAV, after receiving the paging signaling, is switched to a connected state and establishes a connection with the accessed base station. The base station accessed by the UAV may notify its own identifier to the base station accessed by the controller.

In S304, the control information sent by the base station accessed by the controller according to the identifier is received.

After the base station accessed by the UAV notifies its own identifier to the base station accessed by the controller, the base station accessed by the controller may directly send the control information from the controller to the base station accessed by the UAV, and the base station accessed by the UAV may send the control information to the UAV.

According to the embodiment, the identifier of the base station accessed by the UAV is sent to the base station accessed by the controller, and the control information sent by the base station accessed by the controller according to the identifier is received, so that transmission efficiency of the control information is improved.

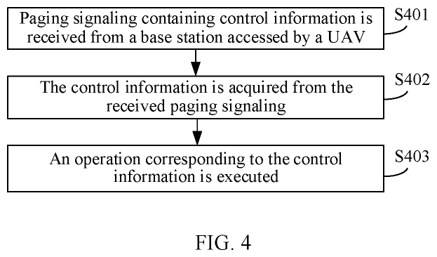

FIG. 4 is a flowchart showing a method for operating a UAV, according to an exemplary embodiment of the present application. The embodiment is described from a UAV side. As shown in FIG. 4, the method for operating a UAV includes the following operations.

In S401, paging signaling containing control information is received from a base station accessed by a UAV.

In S402, the control information is acquired from the received paging signaling.

The UAV, after receiving the paging signaling containing the control information from the base station accessed by it, may acquire the control information from the received paging signaling.

In S403, an operation corresponding to the control information is executed.

The UAV, after acquiring the control information, may execute the operation corresponding to the control information.

According to the embodiment, the paging signaling containing the control information is received from the base station accessed by the UAV, and the operation is executed according to the control information acquired from the paging signaling, so that the operation may be executed according to a control instruction of the controller.

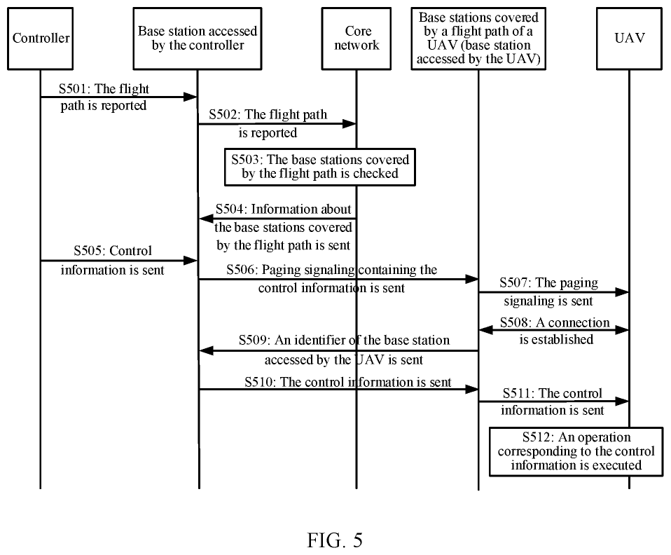

FIG. 5 is a signaling flowchart showing a method for controlling a UAV, according to an exemplary embodiment of the present application. The embodiment is described from the perspective of interaction of a controller, a base station accessed by the controller, a core network, a base station covered by a flight path of a UAV and the UAV. As shown in FIG. 5, the method for controlling a UAV includes the following operations.

In S501, the controller reports the flight path to the base station accessed by the controller.

In S502, the base station accessed by the controller reports the flight path to the core network.

In S503, the core network checks the base stations covered by the flight path.

In S504, the core network sends information about the base stations covered by the flight path to the base station accessed by the controller.

In S505, the controller sends control information to the base station accessed by the controller.

In S506, the base station accessed by the controller sends paging signaling containing the control information to the base stations covered by the flight path.

The base stations covered by the flight path include a base station accessed by the UAV.

In S507, the base station accessed by the UAV sends the paging signaling to the UAV.

In S508, if the UAV is in an idle state, the UAV, after receiving the paging signaling, is switched to a connected state and establishes a connection with the base station accessed by the UAV.

In the embodiment, the UAV in the idle state, after receiving the paging signaling, is switched to the connected state and establishes the connection with the base station accessed by the UAV, thereby providing a condition for subsequent reception of the control information sent by the base station accessed by the UAV.

In S509, the base station accessed by the UAV sends an identifier of the base station accessed by the UAV to the base station accessed by the controller.

In S510, the base station accessed by the controller sends the control information to the base station accessed by the UAV according to the identifier.

In S511, the base station accessed by the UAV sends the control information to the UAV.

In S512, the UAV executes an operation corresponding to the control information.

According to the embodiment, through the interaction of the controller, the base station accessed by the controller, the core network, the base station covered by the flight path of the UAV and the UAV, the base station accessed by the controller sends the paging signaling containing the control information to the base stations covered by the flight path rather than sends the paging signaling to a whole tracking area, so that a paging signaling load is low, and the UAV required to be controlled may be rapidly found and controlled.

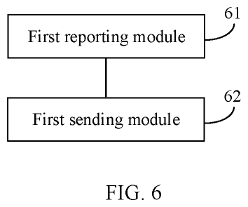

FIG. 6 is a block diagram of a device for controlling a UAV, according to an exemplary embodiment. The device for controlling a UAV may be positioned in a controller. As shown in FIG. 6, the device includes a first reporting module 61 and a first sending module 62.

The first reporting module 61 is configured to report a flight path of a UAV to a core network through a base station accessed by the controller, to enable the base station accessed by the controller to obtain information about base stations covered by the flight path from the core network.

When the controller sets the flight path for the UAV and the UAV takes off, the controller may report the flight path to the base station accessed by it through a cellular network, and then the base station may report the flight path to the core network. In a fixed mode, the flight path of the UAV is fixed, so that the core network may predetermine the base stations in the cellular network that the UAV may pass. The core network, after receiving the flight path reported by the base station accessed by the controller, may check the base stations covered by the flight path and notify information of the base stations to the base station accessed by the controller.

The first sending module 62 is configured to send control information to the base station accessed by the controller, to enable the base station accessed by the controller to send paging signaling containing the control information to the base stations covered by the flight path reported by the first reporting module 61.

When the UAV is required to be found and controlled, the controller may send the control information for the UAV to the base station accessed by it, and the base station accessed by the controller, after receiving the control information, may send the paging signaling to the base stations covered by the flight path, the paging signaling containing the control information.

If there is an X2 interface between the base station and the base station, the paging signaling may be sent through the X2 interface. If there is no X2 interface between the base station and the base station, the paging signaling may be sent through an S1 interface, or the paging signaling is relayed through the X2 interface.

The UAV, after receiving the paging signaling containing the control information from the base station accessed by it, may execute a corresponding operation according to the control information.

According to the embodiment, the flight path of the UAV is reported to the core network through the base station accessed by the controller, to enable the base station accessed by the controller to obtain the information about the base stations covered by the flight path from the core network, and the control information is sent to the base station accessed by the controller to enable the base station accessed by the controller to send the paging signaling containing the control information to the base stations covered by the flight path rather than send the paging signaling to a whole tracking area, so that a paging signaling load is low, and the UAV required to be controlled may be rapidly found and controlled.

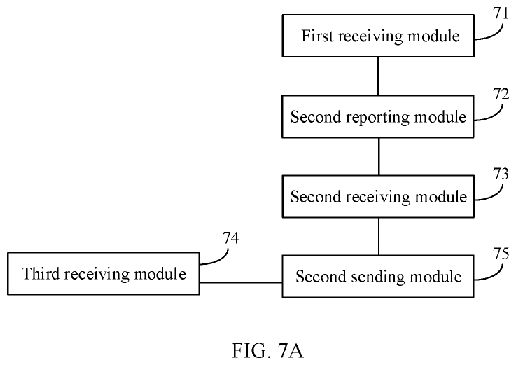

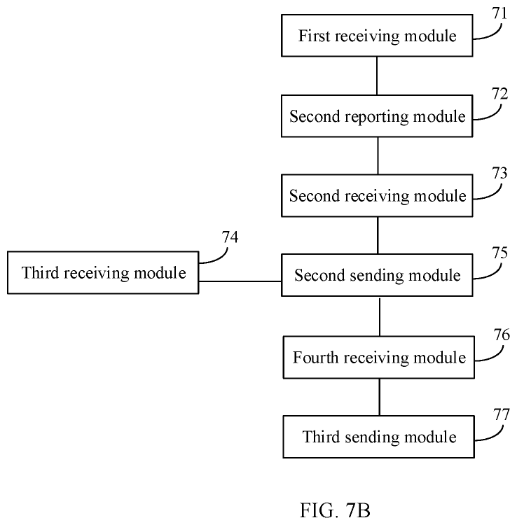

FIG. 7A is a block diagram of another device for controlling a UAV, according to an exemplary embodiment. The device for controlling a UAV may be positioned in a base station accessed by a controller. As shown in FIG. 7A, the device includes a first receiving module 71, a second reporting module 72, a second receiving module 73, a third receiving module 74 and a second sending module 75.

The first receiving module 71 is configured to receive a flight path, reported by the controller, of a UAV.

The second reporting module 72 is configured to report the flight path received by the first receiving module 71 to a core network.

The controller may report the flight path to the base station accessed by it through a cellular network, and then the base station may report the flight path to the core network.

The second receiving module 73 is configured to receive, from the core network, information about base stations covered by the flight path reported by the second reporting module 72.

The core network, after receiving the flight path reported by the base station accessed by the controller, may check the base stations covered by the flight path and notify information of the base stations to the base station accessed by the controller.

The third receiving module 74 is configured to receive control information sent by the controller.

When the UAV is required to be found and controlled, the controller may send the control information for the UAV to the base station accessed by it.

The second sending module 75 is configured to send paging signaling containing the control information received by the third receiving module 74 to the base stations covered by the flight path, to enable a base station accessed by the UAV to send the paging signaling to the UAV.

If there is an X2 interface between the base station accessed by the controller and the base station covered by the flight path, the paging signaling may be sent through the X2 interface. If there is no X2 interface between the base station accessed by the controller and the base station covered by the flight path, the paging signaling may be sent through an S1 interface, or the paging signaling is relayed through the X2 interface.

According to the embodiment, the information about the base stations covered by the flight path is received from the core network, to enable the base station accessed by the controller to send the paging signaling containing the control information to the base stations covered by the flight path rather than send the paging signaling to a whole tracking area, so that a paging signaling load is low, and the UAV required to be controlled may be rapidly found and controlled.

FIG. 7B is a block diagram of another device for controlling a UAV, according to an exemplary embodiment. As shown in FIG. 7B, based on the embodiment shown in FIG. 7A, the device may further include a fourth receiving module 76 and a third sending module 77.

The fourth receiving module 76 is configured to, after the second sending module 75 sends the paging signaling containing the control information to the base stations covered by the flight path, receive an identifier, sent by the base station accessed by the UAV after a connection is established with the UAV, of the base station accessed by the UAV.

After the base station accessed by the UAV sends the paging signaling to the UAV, if the UAV is in an idle state, the UAV, after receiving the paging signaling, is switched to a connected state and establishes a connection with the accessed base station. The accessed base station may notify its own identifier to the base station accessed by the controller. As such, the base station accessed by the controller may subsequently directly send the control information from the controller to the base station accessed by the UAV, and the base station accessed by the UAV may send the control information to the UAV.

The third sending module 77 is configured to send the control information to the base station accessed by the UAV according to the identifier received by the fourth receiving module 76.

According to the embodiment, the identifier, sent by the base station accessed by the UAV after the connection is established with the UAV, of the base station accessed by the UAV is received, and then the base station accessed by the controller may directly send the control information to the base station accessed by the UAV according to the received identifier, so that transmission efficiency of the control information is improved.

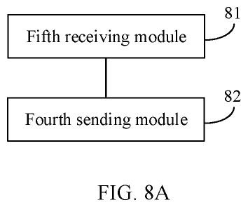

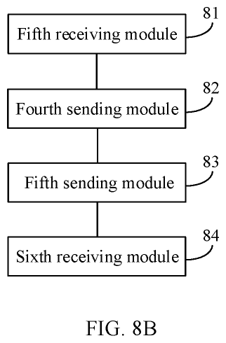

FIG. 8A is a block diagram of another device for controlling a UAV, according to an exemplary embodiment. The device for controlling a UAV may be positioned in a base station accessed by a UAV. As shown in FIG. 8A, the device includes a fifth receiving module 81 and a fourth sending module 82.

The fifth receiving module 81 is configured to receive paging signaling containing control information from a base station accessed by a controller.

When the UAV is required to be found and controlled, the controller may send the control information for the UAV to the base station accessed by it, and the base station accessed by the controller, after receiving the control information, may send the paging signaling to base stations covered by a flight path, the paging signaling containing the control information. The base stations covered by the flight path include the base station accessed by the UAV.

The fourth sending module 82 is configured to send the paging signaling received by the fifth receiving module 81 to the UAV, to enable the UAV to execute an operation corresponding to the control information in the paging signaling.

The base station accessed by the UAV, after receiving the paging signaling containing the control information, may send the paging signaling to the UAV, and the UAV, after receiving the paging signaling, may execute the operation corresponding to the control information in the paging signaling.

According to the embodiment, the paging signaling containing the control information is received from the base station accessed by the controller, and the paging signaling is sent to the UAV for the UAV to execute the operation corresponding to the control information in the paging signaling, so that the UAV required to be controlled may be rapidly found and controlled.

FIG. 8B is a block diagram of another device for controlling a UAV, according to an exemplary embodiment. As shown in FIG. 8B, based on the embodiment shown in FIG. 8A, the device may further include a fifth sending module 83 and a sixth receiving module 84.

The fifth sending module 83 is configured to, after the fourth sending module 82 sends the paging signaling to the UAV, send an identifier of the base station accessed by the UAV to the base station accessed by the controller.

After the base station accessed by the UAV sends the paging signaling to the UAV, if the UAV is in an idle state, the UAV, after receiving the paging signaling, is switched to a connected state and establishes a connection with the accessed base station. The base station accessed by the UAV may notify its own identifier to the base station accessed by the controller.

The sixth receiving module 84 is configured to receive the control information sent by the base station accessed by the controller according to the identifier sent by the fifth sending module 83.

After the base station accessed by the UAV notifies its own identifier to the base station accessed by the controller, the base station accessed by the controller may directly send the control information from the controller to the base station accessed by the UAV, and the base station accessed by the UAV may send the control information to the UAV.

According to the embodiment, the identifier of the base station accessed by the UAV is sent to the base station accessed by the controller, and the control information sent by the base station accessed by the controller according to the identifier is received, so that transmission efficiency of the control information is improved.

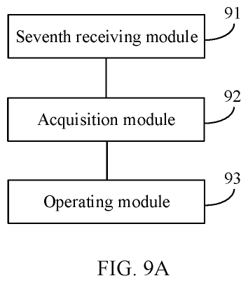

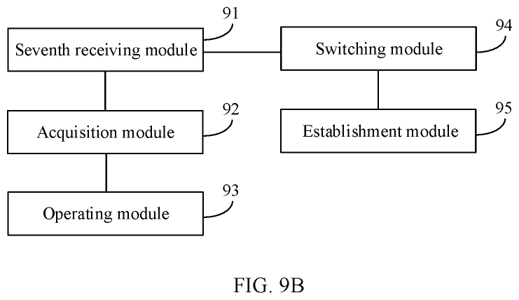

FIG. 9A is a block diagram of a device for operating a UAV, according to an exemplary embodiment. The device for operating a UAV may be positioned in a UAV. As shown in FIG. 9A, the device includes a seventh receiving module 91, an acquisition module 92 and an operating module 93.

The seventh receiving module 91 is configured to receive paging signaling containing control information from a base station accessed by the UAV.

The acquisition module 92 is configured to acquire the control information from the paging signaling received by the seventh receiving module 91.

The UAV, after receiving the paging signaling containing the control information from the base station accessed by it, may acquire the control information from the received paging signaling.

The operating module 93 is configured to execute an operation corresponding to the control information acquired by the acquisition module 92.

The UAV, after acquiring the control information, may execute the operation corresponding to the control information.

According to the embodiment, the paging signaling containing the control information is received from the base station accessed by the UAV, and the operation is executed according to the control information acquired from the paging signaling, so that the operation may be executed according to a control instruction of the controller.

FIG. 9B is a block diagram of another device for operating a UAV, according to an exemplary embodiment. As shown in FIG. 9B, based on the embodiment shown in FIG. 9A, the device may further include a switching module 94 and an establishment module 95.

The switching module 94 is configured to, if the UAV is in an idle state, switch the UAV to a connected state after the seventh receiving module 91 receives the paging signaling.

The establishment module 95 is configured to, after the switching module 94 switches the UAV to the connected state, establish a connection with the base station accessed by the UAV.

In the embodiment, the UAV in the idle state, after receiving the paging signaling, is switched to the connected state and establishes the connection with the base station accessed by the UAV, thereby providing a condition for subsequent reception of the control information sent by the base station accessed by the UAV.

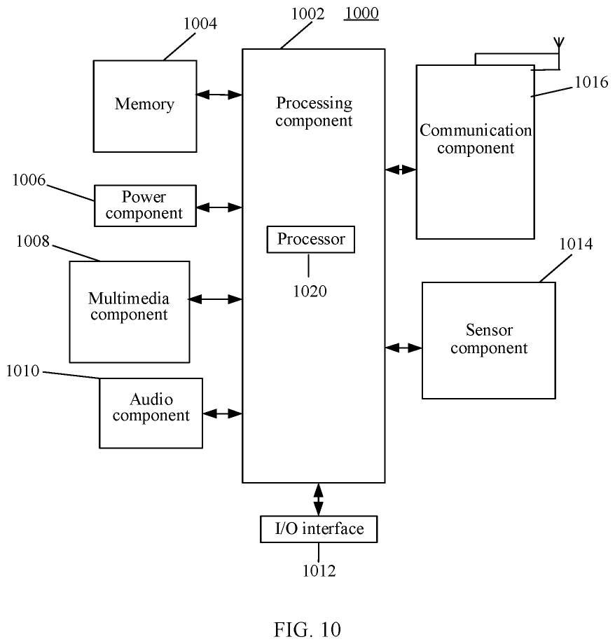

FIG. 10 is a block diagram of a device applied to UAV control, according to an exemplary embodiment. For example, the device 1000 may be a device such as a mobile phone, a computer, a digital broadcast terminal, a messaging device, a gaming console, a tablet, a medical device, exercise equipment and a controller of a UAV.

Referring to FIG. 10, the device 1000 may include one or more of the following components: a processing component 1002, memory 1004, a power component 1006, a multimedia component 1008, an audio component 1010, an Input/Output (I/O) interface 1012, a sensor component 1014, and a communication component 1016.

The processing component 1002 typically controls overall operations of the device 1000, such as the operations associated with display, telephone calls, data communications, camera operations, and recording operations. The processing component 1002 may include one or more processors 1020 to execute instructions to perform all or part of the steps in the abovementioned method. Moreover, the processing component 1002 may include one or more modules which facilitate interaction between the processing component 1002 and the other components. For instance, the processing component 1002 may include a multimedia module to facilitate interaction between the multimedia component 1008 and the processing component 1002.

One processor 1020 in the processing component 1002 may be configured to perform the following operations.

A flight path of a UAV is reported to a core network through a base station accessed by a controller, to enable the base station accessed by the controller to obtain information about base stations covered by the flight path from the core network.

Control information is sent to the base station accessed by the controller, to enable the base station accessed by the controller to send paging signaling containing the control information to the base stations covered by the flight path.

The memory 1004 is configured to store various types of data to support the operation of the device 1000. Examples of such data include instructions for any application programs or methods operated on the device 1000, contact data, phonebook data, messages, pictures, video, etc. The memory 1004 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power component 1006 provides power for various components of the device 1000. The power component 1006 may include a power management system, one or more power supplies, and other components associated with generation, management and distribution of power for the device 1000.

The multimedia component 1008 includes a screen providing an output interface between the device 1000 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. In some embodiments, the multimedia component 1008 includes a front camera and/or a rear camera. The front camera and/or the rear camera may receive external multimedia data when the device 1000 is in an operation mode, such as a photographing mode or a video mode. Each of the front camera and the rear camera may be a fixed optical lens system or have focusing and optical zooming capabilities.

The audio component 1010 is configured to output and/or input an audio signal. For example, the audio component 1010 includes a Microphone (MIC), and the MIC is configured to receive an external audio signal when the device 1000 is in the operation mode, such as a call mode, a recording mode and a voice recognition mode. The received audio signal may further be stored in the memory 1004 or sent through the communication component 1016. In some embodiments, the audio component 1010 further includes a speaker configured to output the audio signal.

The I/O interface 1012 provides an interface between the processing component 1002 and a peripheral interface module, and the peripheral interface module may be a keyboard, a click wheel, a button and the like. The button may include, but not limited to: a home button, a volume button, a starting button and a locking button.

The sensor component 1014 includes one or more sensors configured to provide status assessment in various aspects for the device 1000. For instance, the sensor component 1014 may detect an on/off status of the device 1000 and relative positioning of components, such as a display and small keyboard of the device 1000, and the sensor component 1014 may further detect a change in a position of the device 1000 or a component of the device 1000, presence or absence of contact between the user and the device 1000, orientation or acceleration/deceleration of the device 1000 and a change in temperature of the device 1000. The sensor component 1014 may include a proximity sensor configured to detect presence of an object nearby without any physical contact. The sensor component 1014 may also include a light sensor, such as a Complementary Metal Oxide Semiconductor (CMOS) or Charge Coupled Device (CCD) image sensor, configured for use in an imaging application. In some embodiments, the sensor component 1014 may also include an acceleration sensor, a gyroscope sensor, a magnetic sensor, a pressure sensor or a temperature sensor.

The communication component 1016 is configured to facilitate wired or wireless communication between the device 1000 and another device. The device 1000 may access a communication-standard-based wireless network, such as a Wireless Fidelity (WiFi) network, a 2nd-Generation (2G) or 3rd-Generation (3G) network or a combination thereof. In an exemplary embodiment, the communication component 1016 receives a broadcast signal from an external broadcast management system or broadcasts related information through a broadcast channel. In an exemplary embodiment, the communication component 1016 further includes a Near Field Communication (NFC) module to facilitate short-range communication. For example, the NFC module may be implemented based on a Radio Frequency Identification (RFID) technology, an Infrared Data Association (IrDA) technology, an Ultra-WideBand (UWB) technology, a Bluetooth (BT) technology and another technology.

In an exemplary embodiment, the device 1000 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, there is also provided a non-transitory computer-readable storage medium including an instruction, such as the memory 1004 including an instruction, and the instruction may be executed by the processor 1020 of the device 1000 to implement the abovementioned method. For example, the non-transitory computer-readable storage medium may be a ROM, a Random-Access Memory (RAM), a Compact Disc Read-Only Memory (CD-ROM), a magnetic tape, a floppy disc, an optical data storage device and the like.

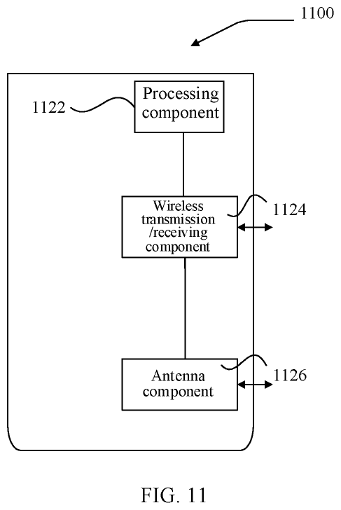

FIG. 11 is a block diagram of another device applied to UAV control, according to an exemplary embodiment. The device 1100 may be provided as a base station, and the base station may be a base station accessed by a controller and may also be a base station accessed by a UAV. Referring to FIG. 11, the device 1100 includes a processing component 1122, a wireless transmission/receiving component 1124, an antenna component 1126 and a wireless interface-specific signal processing part, and the processing component 1122 may further include one or more processors.

When the base station is the base station accessed by the controller, one processor in the processing component 1122 may be configured to perform the following operations.

A flight path, reported by the controller, of a UAV is received.

The flight path is reported to a core network.

Information about base stations covered by the flight path is received from the core network.

Control information sent by the controller is received.

Paging signaling containing the control information is sent to the base stations covered by the flight path, to enable a base station accessed by the UAV to send the paging signaling to the UAV.

When the base station is the base station accessed by the UAV, one processor in the processing component 1122 may be configured to perform the following operations.

Paging signaling containing control information is received from a base station accessed by a controller.

The paging signaling is sent to the UAV for the UAV to execute an operation corresponding to the control information in the paging signaling.

In an exemplary embodiment, there is also provided a non-transitory computer-readable storage medium including an instruction, and the instruction may be executed by the processing component 1122 of the device 1100 to implement the method for controlling a UAV. For example, the non-transitory computer-readable storage medium may be a ROM, a RAM, a CD-ROM, a magnetic tape, a floppy disc, an optical data storage device and the like.

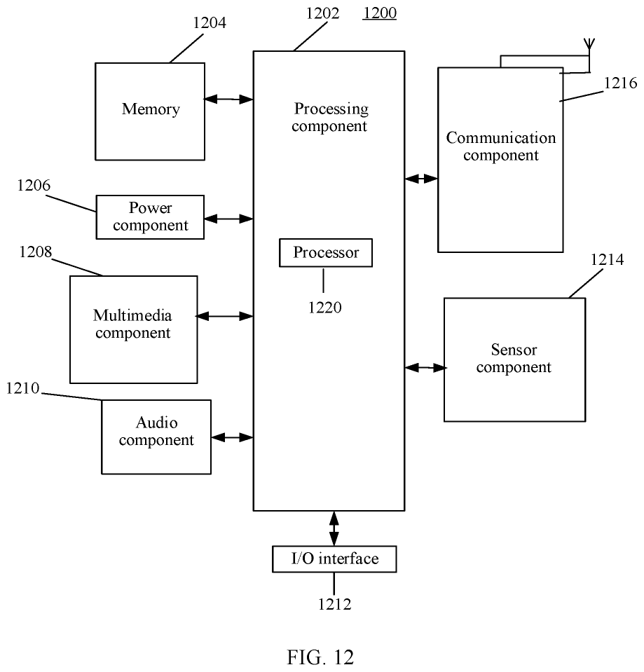

FIG. 12 is a block diagram of a device applied to UAV operation, according to an exemplary embodiment. For example, the device 1200 may be a device such as a mobile phone, a computer, a digital broadcast terminal, a messaging device, a gaming console, a tablet, a medical device, exercise equipment and a UAV.

Referring to FIG. 12, the device 1200 may include one or more of the following components: a processing component 1202, memory 1204, a power component 1206, a multimedia component 1208, an audio component 1210, an I/O interface 1212, a sensor component 1214, and a communication component 1216.

The processing component 1202 typically controls overall operations of the device 1200, such as the operations associated with display, telephone calls, data communications, camera operations, and recording operations. The processing component 1202 may include one or more processors 1220 to execute instructions to perform all or part of the steps in the abovementioned method. Moreover, the processing component 1202 may include one or more modules which facilitate interaction between the processing component 1202 and the other components. For instance, the processing component 1202 may include a multimedia module to facilitate interaction between the multimedia component 1208 and the processing component 1202.

One processor 1220 in the processing component 1202 may be configured to perform the following operations.

Paging signaling containing control information is received from a base station accessed by a UAV.

The control information is acquired from the received paging signaling.

An operation corresponding to the control information is executed.

The memory 1204 is configured to store various types of data to support the operation of the device 1200. Examples of such data include instructions for any application programs or methods operated on the device 1200, contact data, phonebook data, messages, pictures, video, etc. The memory 1204 may be implemented by any type of volatile or non-volatile memory devices, or a combination thereof, such as an SRAM, an EEPROM, an EPROM, a PROM, a ROM, a magnetic memory, a flash memory, and a magnetic or optical disk.

The power component 1206 provides power for various components of the device 1200. The power component 1206 may include a power management system, one or more power supplies, and other components associated with generation, management and distribution of power for the device 1200.

The multimedia component 1208 includes a screen providing an output interface between the device 1200 and a user. In some embodiments, the screen may include an LCD and a TP. If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. In some embodiments, the multimedia component 1208 includes a front camera and/or a rear camera. The front camera and/or the rear camera may receive external multimedia data when the device 1200 is in an operation mode, such as a photographing mode or a video mode. Each of the front camera and the rear camera may be a fixed optical lens system or have focusing and optical zooming capabilities.

The audio component 1210 is configured to output and/or input an audio signal. For example, the audio component 1210 includes a MIC, and the MIC is configured to receive an external audio signal when the device 1200 is in the operation mode, such as a call mode, a recording mode and a voice recognition mode. The received audio signal may further be stored in the memory 1204 or sent through the communication component 1216. In some embodiments, the audio component 1210 further includes a speaker configured to output the audio signal.

The I/O interface 1212 provides an interface between the processing component 1202 and a peripheral interface module, and the peripheral interface module may be a keyboard, a click wheel, a button and the like. The button may include, but not limited to: a home button, a volume button, a starting button and a locking button.

The sensor component 1214 includes one or more sensors configured to provide status assessment in various aspects for the device 1200. For instance, the sensor component 1214 may detect an on/off status of the device 1200 and relative positioning of components, such as a display and small keyboard of the device 1200, and the sensor component 1214 may further detect a change in a position of the device 1200 or a component of the device 1200, presence or absence of contact between the user and the device 1200, orientation or acceleration/deceleration of the device 1200 and a change in temperature of the device 1200. The sensor component 1214 may include a proximity sensor configured to detect presence of an object nearby without any physical contact. The sensor component 1214 may also include a light sensor, such as a CMOS or CCD image sensor, configured for use in an imaging application. In some embodiments, the sensor component 1214 may also include an acceleration sensor, a gyroscope sensor, a magnetic sensor, a pressure sensor or a temperature sensor.

The communication component 1216 is configured to facilitate wired or wireless communication between the device 1200 and another device. The device 1200 may access a communication-standard-based wireless network, such as a Wi-Fi network, a 2G or 3G network or a combination thereof. In an exemplary embodiment, the communication component 1216 receives a broadcast signal from an external broadcast management system or broadcasts related information through a broadcast channel. In an exemplary embodiment, the communication component 1216 further includes an NFC module to facilitate short-range communication. For example, the NFC module may be implemented based on an RFID technology, an IrDA technology, an UWB technology, a BT technology and another technology.

In an exemplary embodiment, the device 1200 may be implemented by one or more ASICs, DSPs, DSPDs, PLDs, FPGAs, controllers, micro-controllers, microprocessors or other electronic components, and is configured to execute the abovementioned method.

In an exemplary embodiment, there is also provided a non-transitory computer-readable storage medium including an instruction, such as the memory 1204 including an instruction, and the instruction may be executed by the processor 1220 of the device 1200 to implement the abovementioned method. For example, the non-transitory computer-readable storage medium may be a ROM, a RAM, a CD-ROM, a magnetic tape, a floppy disc, an optical data storage device and the like.

The device embodiments substantially correspond to the method embodiments, and reference can be made to the description of the method embodiments for relevant parts. The device embodiment described above is only schematic, units described as separate parts therein may or may not be physically separated, and parts displayed as units may or may not be physical units, and namely may be located in the same place or may also be distributed to multiple network units. Part or all of the modules therein may be selected according to a practical requirement to achieve the purpose of the solutions of the embodiments. Those of ordinary skill in the art may understand and implement without creative work.

It is to be noted that relational terms “first,” “second” and the like in the present disclosure are used solely to distinguish one entity or operation from another entity or operation without necessarily requiring or implying any actual such relationship or order between such entities or operations. Terms “include” and “have” or any other variation thereof is intended to cover nonexclusive inclusions, so that a process, method, object or device including a series of elements not only includes those elements, but also includes other elements that are not clearly listed, or further includes elements intrinsic to the process, the method, the object or the device. Without any more limitations, an element defined by statement “including a/an . . . ” does not exclude existence of another same element in a process, method, object or device including the element.

Other embodiments of the present disclosure will be apparent to those skilled in the art from consideration of the specification and practice of the present disclosure disclosed herein. This application is intended to cover any variations, uses, or adaptations of the present disclosure following, in general, the principles of the disclosure, and including such departures from the present disclosure as come within known or customary practice within the art to which the invention pertains. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1.-8. (canceled)

9. A device for controlling an Unmanned Aerial Vehicle (UAV), applied to a controller and comprising:
a processor; and
memory storing a set of instructions executable by the processor,
wherein the processor is configured to:
report a flight path of a UAV to a core network through a base station accessed by the controller, to enable the base station accessed by the controller to obtain information about base stations covered by the flight path from the core network; and
send control information to the base station accessed by the controller, to enable the base station accessed by the controller to send paging signaling containing the control information to the base stations covered by the flight path.

10. A device for controlling an Unmanned Aerial Vehicle (UAV), applied to a base station accessed by a controller and comprising:
a processor; and
memory storing a set of instructions executable by the processor,
wherein the processor is configured to:
receive a flight path, reported by the controller, of a UAV;
report the flight path to a core network;
receive information about base stations covered by the flight path from the core network;
receive control information sent by the controller; and
send paging signaling containing the control information to the base stations covered by the flight path, to enable a base station accessed by the UAV to send the paging signaling to the UAV.

11. The device of claim 10, wherein the processor is further configured to:
send the paging signaling containing the control information to the base stations covered by the flight path through an X2 interface or an S1 interface.

12. The device of claim 10, wherein the processor is further configured to:
sending the paging signaling containing the control information to the base stations covered by the flight path, receive an identifier, sent by the base station accessed by the UAV after a connection is established with the UAV, of the base station accessed by the UAV; and
send the control information to the base station accessed by the UAV according to the identifier.

13. A device for controlling an Unmanned Aerial Vehicle (UAV), applied to a base station accessed by a UAV and comprising:
a processor; and
memory storing a set of instructions executable by the processor,
wherein the processor is configured to:
receive paging signaling containing control information from a base station accessed by a controller; and
send the paging signaling to the UAV, for the UAV to execute an operation corresponding to the control information in the paging signaling.

14. The device of claim 13, wherein the processor is further configured to:
sending the paging signaling to the UAV, send an identifier of the base station accessed by the UAV to the base station accessed by the controller; and
receive the control information sent by the base station accessed by the controller according to the identifier.

15. A device for operating an Unmanned Aerial Vehicle (UAV), applied to a UAV and comprising:
a processor; and
memory storing a set of instructions executable by the processor,
wherein the processor is configured to:
receive paging signaling containing control information from a base station accessed by the UAV;
acquire the control information from the paging signaling; and
execute an operation corresponding to the control information.

16. The device of claim 15, wherein the processor is further configured to:
in a case that the UAV is in an idle state, switch the UAV to a connected state after receiving the paging signaling; and
switching the UAV to the connected state, establish a connection with the base station accessed by the UAV.

17.-24. (canceled)

25. The device of claim 9, wherein the processor is further configured to:
report the flight path to the base station accessed by the controller through a cellular network.

26. The device of claim 10, wherein the base stations covered by the flight path comprise the base station accessed by the UAV.

27. The device of claim 12, wherein the control information is from the controller, and the processor is further configured to:
send the control information from the controller to the base station accessed by the UAV according to the received identifier.

28. The device of claim 14, wherein the control information is from the controller, and the processor is further configured to:
receive the control information from the controller, sent by the base station accessed by the controller according to the identifier.

29. The device of claim 14, wherein the processor is further configured to:
send the control information to the UAV.

30. A UAV system comprising the device according to claim 9, wherein the system is configured to send the paging signaling to the UAV for the UAV to execute operations according to the control information in the paging signaling, to thereby rapidly locate and control the UAV.

31. The UAV system according to claim 30, further comprising the base station accessed by the controller, configured to:
obtain the information about the base stations covered by the flight path from the core network; and
send the paging signaling containing the control information to the base stations covered by the flight path, but not to a whole tracking area, to thereby reduce a paging signaling load.

32. The UAV system according to claim 31, further comprising the core network, configured to send the information about the base stations covered by the flight path to the base station accessed by the controller.

33. The UAV system according to claim 32, further comprising the UAV, configured to receive the paging signaling containing the control information from the base station accessed by the UAV, and execute the operations according to the control information.
